(19) United States
(12) Patent Application Publication
(10) Pub. No.: US 2023/0026016 A1
(43) Pub. Date: Jan. 26, 2023

(54) Shower Head Cleaner Containment Bag

(71) Applicant: Stephanie Leverich, Valparaiso, IN (US)

(72) Inventor: Stephanie Leverich, Valparaiso, IN (US)

(21) Appl. No.: 17/870,586

(22) Filed: Jul. 21, 2022

Related U.S. Application Data
(60) Provisional application No. 63/224,140, filed on Jul. 21, 2021.

(51) Int. Cl. B05B 15/55; B08B 3/08

(52) U.S. Cl. CPC B05B 15/55; B08B 3/08

(57) ABSTRACT

A containment device for cleaning agents or other liquids to attach to a showerhead, faucet, or other plumbing fixture outlet that may serve as an effective means of solvent containment and promote a more effective delivery system for a cleaning agent, the containment device comprising a housing, wherein the housing comprises a top, an opening disposed on the top, a bottom, a hollow interior, an interior surface, and an exterior surface, wherein the housing is shaped to fit around a showerhead, and wherein the housing is configured to contain a solvent cleaning agent.

### CROSS-REFERENCES TO RELATED APPLICATIONS

This application claims priority to U.S. Patent Application No. 63/224,140, titled “Shower Head Cleaner Containment Bag,” and filed on Jul. 21, 2021. The entire application is incorporated herein by reference in its entirety.

### FIELD OF INVENTION

The present invention relates generally to an apparatus for use in household cleaning and maintenance. More particularly, the present invention is related to a containment device for cleaning agents or other liquids to attach to a showerhead, faucet, or other plumbing fixture outlet.

### BACKGROUND OF THE INVENTION

It is well established that it can be difficult to disinfect, clean and unclog a showerhead or similar spray head apparatus that is designed to allow water to flow through. Theses apparatuses are generally designed with tiny holes, which are prone to accumulate limescale, rust, dirt, as well as soap scum, skin residue, and odor-causing bacteria.

According to most Manufacturer's directions for cleaning and maintenance, a person is meant to spray the cleaner directly onto the showerhead or spray head apparatus, allow the cleaner to soak for 30 minutes, run the shower or water source to rinse, and then wipe the surface clean. This cleaning method presents a problem, as it requires the person performing this task to spray harsh, sometimes toxic, chemicals or other cleaning agents onto the showerhead or spray head apparatus, often located over the person's head. This presents the risk of potential drips onto clothing and/or irritants coming into contact with skin or eyes. Further, it is difficult to effectively soak the showerhead or spray head without continuously reapplying the cleaning agent and wasting a great deal of the product in the process. Alternatively, a person may remove the plumbing fixture prior to cleaning it. However, it may be difficult, inconvenient, and time-consuming to first remove the plumbing fixture before soaking it, and then subsequently reattaching the plumbing fixture after it has been cleaned. Furthermore, it may be the case that some plumbing fixtures are permanent and immovable, thus making it impossible to remove such fixture from its location.

Some users may resort to filling a shopping bag or sandwich bag with the shower cleaner and attempt to affix such bags to the shower head or spray head with a rubber band, twist tie or some other method of securing the bag. Methods such as these are potentially unsafe and unsanitary, as these bags are not designed for chemical containment purposes and many of chemicals designed for descaling are solvents which may cause such bags to break down, leading to holes and leakage.

There exists a need to address the issue of cleaning a spray head or showerhead without risk of chemical exposure, minimizing drips and/or skin or eye irritant exposure.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention comprise a containment device for cleaning agents or other liquids to attach to a showerhead, faucet, or other plumbing fixture outlet. Embodiments of the present invention may serve as an effective means of solvent containment and may promote a more effective delivery system of the cleaning agent dissolving properties. Thus, embodiments of the present invention may provide a safer delivery method for cleaning and disinfecting any spray apparatus.

Some embodiments may comprise a solvent-friendly, non-BPA material that could be secured over the shower head or spray head apparatus, without the risk of drips, leaks, harmful chemical interactions and with minimal exposure of the solvent cleaner to the person performing the task. Embodiments of the present invention may be constructed as a continuous medium, without seams or corners, to reduce the possibility of leaks and to simplify production. Some embodiments may be equipped with an adjustable, elastic drawstring. Some embodiments may include an absorbent or wicking material inside the bag to improve the contact between the cleaning agent and the shower head or spray head apparatus. Some embodiments may include an absorbent or wicking material pre-treated with a cleaning agent.

Some embodiments may be constructed from multiple layers. Accordingly, some embodiments may comprise a chemical layer that includes a cleaning agent, and a containment layer that covers the chemical layer. It is further contemplated that the chemical layer may be disposed on top of the containment layer in such a manner that when the coupled unified layers are formed into a bag, the chemical layer may form the interior surface of the bag, and the containment layer may form the exterior surface of the bag.

### BRIEF DESCRIPTION OF THE DRAWINGS

The present invention is described in detail below with reference to the attached drawing figures, wherein:

FIG. 1 provides a prospective view of an exemplary embodiment in accordance with the present invention.

FIG. 2 provides a prospective view of an exemplary embodiment further comprising an absorbent or wicking material in accordance with the present invention.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

Embodiments of the present invention comprise a containment device for cleaning agents or other liquids to attach to a showerhead, faucet, or other plumbing fixture outlet. Embodiments of the present invention may serve as an effective means of solvent containment and may promote a more effective delivery system of the cleaning agent dissolving properties. Thus, embodiments of the present invention may provide a safer delivery method for cleaning and disinfecting any spray apparatus. Embodiments may be used in conjunction with various cleaning agents, including but not limited to lactic acid and gluconic acid based products, vinegar, ammonia based products, as well as non-cleaning agents, such as essential oils for aroma therapy applications.

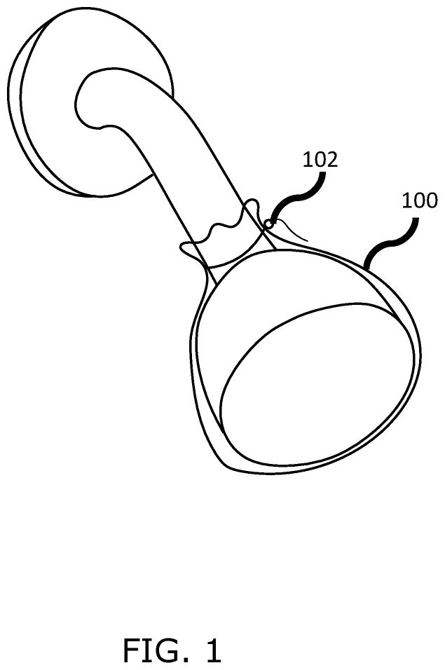

FIG.1 provides a prospective view of an exemplary shower cleaner containment bag 100 embodiment in accordance with the present invention. Some embodiments may comprise a solvent-friendly, non-BPA material that could be secured over the shower head or spray head apparatus, without the risk of drips, leaks, harmful chemical interactions and with minimal exposure of the solvent cleaner to the person performing the task. Embodiments of the present invention may be constructed as a continuous medium, without seams or corners, to reduce the production of leaks and to simplify production. With continued reference to FIG. 1, some embodiments may be is equipped with an adjustable, elastic drawstring 102.

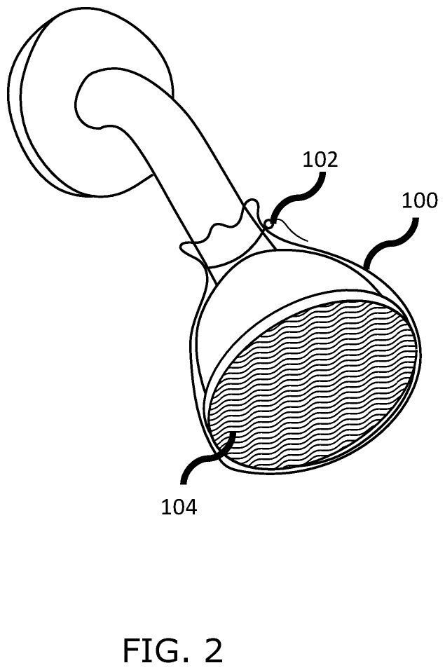

FIG. 2 provides a prospective view of an exemplary shower cleaner containment bag 100 embodiment further comprising a absorbent or wicking material 104 in accordance with the present invention. Some embodiments may include an absorbent or wicking material inside the bag to improve the contact between the cleaning agent and the shower head or spray head apparatus. Such absorbent or wicking material may include, but are not limited to, natural sponge, synthetic sponge composed of polyester, polyurethane, vegetal cellulose, or the like, cotton or wool felt, cotton balls, gauze, capillary matting, or similar materials.

In some embodiments, the cleaning agent may be combined with the absorbent or wicking material inside the bag.

In some embodiments, the shower head cleaning containment bag may be constructed from multiple layers. For example, it is contemplated that the bag may be constructed from two layers: a chemical layer that includes a cleaning agent, and a containment layer that covers the chemical layer. It is further contemplated that the chemical layer may be disposed on top of the containment layer in such a manner that when the coupled unified layers are formed into a bag, the chemical layer forms the interior surface of the bag, while the containment layer forms the exterior surface of the bag. Such an embodiment allows the cleaning agent to make direct contact with the shower head, while at the same time prevents a user from ever coming in direct contact with the cleaning agent.

Some embodiments may include a resealable closure, allowing the absorbent or wicking material to remain saturated with cleaning agent when not in use without drying out from exposure to the air. Such embodiments may be provided pre-treated with cleaning agent to simplify delivery of the cleaning product.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A device for the containment of cleaning chemicals, the device comprising
a housing, wherein the housing comprises
a top,
an opening disposed on the top,
a bottom,
a hollow interior,
an interior surface, and
an exterior surface,
wherein the housing is shaped to fit around a shower head, and
wherein the housing is configured to contain a cleaning agent.

2. The device of claim 1, wherein the housing comprises BPA-free plastic.

3. The device of claim 1, wherein the device is seamlessly constructed from a single piece of material.

4. The device of claim 1, wherein the device further comprises an adjustable drawstring.

5. The device of claim 1, wherein the device is resealable.

6. The device of claim 1, wherein the device further comprises an absorbent material.

7. The device of claim 6, wherein the absorbent material is pre-treated with a cleaning agent.

8. The device of claim 6, wherein the absorbent material is any one of the following: [list]

9. An device for cleaning a shower head, the device comprising
a top, wherein an opening is disposed on the top,
a bottom, wherein the bottom is a closed bottom,
an interior surface, wherein a chemical layer is disposed on the interior surface, and wherein the chemical layer is pre-treated with a cleaning agent,
an exterior surface, wherein a container layer is disposed on the exterior surface, and wherein the containment layer is configured to contain the chemical layer pre-treated with the cleaning agent,
wherein the chemical layer and the containment layer are coupled together in a manner so that the chemical layer forms the interior surface of the bag and the containment layer forms the exterior surface of the bag, and
a hollow interior, wherein the hollow interior is configured fit around a shower head.

10. The device of claim 9, wherein the device comprises a BPA-free plastic.

11. The device of claim 9, wherein the device is seamlessly constructed as a continuous medium.

12. The device of claim 9, wherein the device further comprises an adjustable drawstring.

13. The device of claim 9, wherein the device is resealable.

14. The device of claim 9, wherein the device further comprises an absorbent material.

15. The apparatus of claim 14, wherein the absorbent material is pre-treated with a cleaning agent.

16. The apparatus of claim 14, wherein the absorbent material is any one of the following:
natural sponge, synthetic sponge composed of polyester, polyurethane, vegetal cellulose, like, cotton or wool felt, cotton balls, gauze, or capillary matting.

17. A method for cleaning a shower head using a shower head cleaner containment bag, the method comprising the steps of
applying a cleaning agent to an absorbent material contained within a shower head cleaner containment bag,
covering a shower head with the bag,
adjusting the bag to fit around the shower head,
waiting for an adequate amount of time to allow the cleaning agent to clean the shower head,
removing the bag after an adequate amount of time has passed, and
sealing the bag after removal to prevent the cleaning agent from evaporating.
